(19) United States
(12) Patent Application Publication
(10) Pub. No.: US 2012/0327525 A1
(43) Pub. Date: Dec. 27, 2012

(54) LENS ACTUATOR FOR FOCUSING

(76) Inventor: Han Sang Lee, Seoul (KR)

(21) Appl. No.: 13/583,040

(22) PCT Filed: Feb. 16, 2011
(86) PCT No.: PCT/KR2011/001017

§ 371 Date: Sep. 6, 2012

(30) Foreign Application Priority Data
Mar. 11, 2010 (KR) 10-2010-0021983

(51) Int. Cl. G02B 7/04

(52) U.S. Cl. 359/823

(57) ABSTRACT

Disclosed is a lens actuator for focusing. The lens actuator has a bracket with a retaining groove provided in an optical axial direction of a movable lens means, a dial for focusing rotatably supported by the bracket and having a ring-shaped groove offset from a rotation center, and a lens-actuating member which includes a guide projection inserted into the ring-shaped groove, a protruding portion inserted into the retaining groove of the bracket, and a lens-actuating shaft extending out from the bracket. The lens actuator further has a lens actuator housing, and a shock-buffering means. When the dial is rotated, the lens-actuating shaft is moved forward and backward in an optical axial direction by the combined forces applied by the offset ring-shaped groove guiding the guide projection and the retaining groove allowing the protruding portion to move in the optical axial direction, but not in a direction of the lens-actuating shaft.

### FIELD OF TECHNOLOGY

The present invention relates to a lens actuator, more specifically to a lens actuator for focusing with which a lens can be moved in an optical axial direction to a predetermined position through the control of a user to adjust focus.

### BACKGROUND OF TECHNOLOGY

Various optical devices using lens need to adjust the focus of lens. The adjustment of focus of lens is accomplished by moving the lens in its optical axial direction and positioning it at an optimal location. For example, a projector device enlarges and projects an image converted from video signal on a screen through a projecting lens. For adjusting the focus of the lens with respect to the screen, the very projecting lens or additional lens for adjusting focus must be configured so as to be moved forward and backward along the optical axial direction of the lens. And a lens actuator for powering the movement of such lens is needed.

Recently a projector device manufactured small has been introduced. Especially a micro projector manufactured so small to be embedded in a mobile phone has been introduced to a market. In cases of such micro projectors, an undesirable external force may press down a dial for adjusting focus of the lens actuator during its carriage or usage. Such an external force may cause a deformation or bending of the lens actuator, or damage them in worst cases.

Also, if the rotation range of the dial for adjusting focus is limited, a part supporting the dial may be broken by a user's forced operation (for example, an operation of applying excessive force for rotating the dial beyond the maximum rotation range) or unwanted external force. Therefore, the dial had better be configured to rotate indefinitely. And it would be convenient if the dial can be rotated in any directions, clockwise or counterclockwise, for adjusting focus of the lens.

### DETAILED DESCRIPTION OF INVENTION

### Problem to Solve

An object of the invention is to provide a lens actuator for focusing, which satisfies all the above requirements. That is, the invention is to provide a lens actuator, which enables the user to adjust conveniently the focus that the user wants by making an actuated lens (that is, a movable lens) reciprocate one time over a predetermined distance in its optical axial direction using a force generated when the user rotates the dial for focusing by one full revolution in an arbitrary direction.

Also, another object of the invention is to provide a lens actuator for focusing, in which even though the dial is rotated indefinitely clockwise or counterclockwise the actuated lens keeps moving forward and backward over a predetermined distance along its optical axial direction.

Still another object of the invention is to provide a lens actuator for focusing, which buffers external shock applied to the dial, so as to prevent it from being deformed, bent, or damaged.

### Solution to Problems

According to an embodiment of the invention for accomplishing the above purposes, disclosed is a lens actuator for focusing, comprises: a bracket in which a retaining groove extends along an optical axial direction of a movable lens means; a dial for focusing rotatably supported by the bracket, and including a ring-shaped groove offset from a rotation center on at least one body surface; and a lens-actuating member including: a guide projection inserted into the ring-shaped groove; a protruding portion inserted into the retaining groove of the bracket; and a lens-actuating shaft extending out from the bracket, wherein when the dial is rotated clockwise or counterclockwise the lens-actuating shaft is moved forward and backward by a predetermined distance in an optical axial direction by means of the combined forces imparted or applied by the offset ring-shaped groove guiding the guide projection and the retaining groove allowing the protruding portion to move in an optical axial direction but not in a direction of the lens-actuating shaft that is perpendicular to the optical axial direction.

In the above lens actuator, preferably if the dial keeps rotating clockwise or counterclockwise, the lens-actuating shaft is configured to keep moving forward and backward one time by the predetermined distance along the optical axial direction for every rotational period or for every revolution of the dial.

Also, in the above lens actuator, the lens-actuating shaft of which end is inserted and engaged into the movable lens means delivers a force to the movable lens means so as to move forward and backward by the predetermined distance along the optical axial direction when the lens-actuating shaft moves forward and backward in the optical axial direction. In such a case, preferably the lens actuator may further comprise a lens-assembly housing for receiving the movable lens slidably along a guide member provided in the optical axial direction.

The lens actuator may further comprise a lens actuator housing which receives an assembly of the dial, the lens-actuating member, and the bracket therein and is fixed to a lens-assembly housing in which the movable lens means is installed while exposing a portion of the dial and a portion of the lens-actuating shaft to outside of top and bottom thereof. In this case, preferably an engaging means for fixing the lens actuator housing to the lens-assembly housing may be provided in at least one of the lens actuator housing and the lens-assembly housing.

Preferably, the lens actuator may further comprise a shock-buffering means, which is disposed between the bracket and the lens actuator housing, makes the bottom of the bracket detached from the floor of the lens actuator housing, and buffers shock against an external force when there exists an external force pressing down on the dial. In this case, preferably, in one side surface of the bracket may be further provided a retaining protrusion, and in a corresponding side surface of the lens actuator housing may be further provided a retaining groove for restraining the retaining protrusion inserted therein so as not to disengage and allowing movement only within a predetermined distance in the direction of the lens actuating shaft.

Also, the lens actuator may further comprise an engaging means for fixing the bracket to the lens-assembly housing in at least one of the lens-assembly housing in which the movable lens is installed and the bracket. In this case, the lens actuator may further comprise a shock-buffering means, which is disposed between the bracket and the lens-assembly housing, makes the bottom of the bracket detached from the floor of the lens-assembly housing, and buffers shock against an external force before the bottom of the bracket touches the surface of the lens-assembly housing when there exists the external force pressing down on the dial.

Lastly, in the above lens actuator, the dial is provided with a rotational axis at the center of rotation of a body having a shape of disc or wheel, and the portion of the body enclosing the rotational axis and enclosed by the offset ring-shaped groove functions as a cam with respect to the lens-actuating member.

### Advantages

According to such a lens actuator, the focus of lens may be adjusted by rotating within a single revolution of a dial for focusing irrespective of a rotational direction, clockwise or counterclockwise.

Also, since the rotation range of the dial for focusing is indefinite, there is no damage due to excessive rotation of the dial.

And damages from an external shock may be reduced, for even though an external shock pressing down on the dial for focusing from above the shock is not delivered directly to a bracket supporting the dial but a spring, a shock-buffering means, absorbs it and recovers.

### BRIEF DESCRIPTION OF DRAWINGS

FIGS. 1 and 2 are exploded perspective views showing a lens actuator (10) for focusing according to a preferred embodiment of the present invention from different perspectives, respectively;

FIGS. 3(a) and 3(b) are assembled views showing an assembled state of some components of the lens actuator (10) from the top and the bottom;

FIGS. 4(a) and 4(b) are assembled views showing the assembled states of the lens actuator (10) having a lens actuator housing (600) from the top and the bottom;

FIGS. 5 and 6 are an exploded perspective view and an assembled view, respectively, showing how to assemble the lens actuator (10), a lens assembly (700), and a lens-assembly housing (800);

FIGS. 7(a)-(c) show operational states of the lens actuator (10); and

FIG. 8 shows a mobile phone with a micro projector adopting the lens actuator (10) according to the invention as a component.

### DETAILED DESCRIPTION OF EMBODIMENTS OF INVENTION

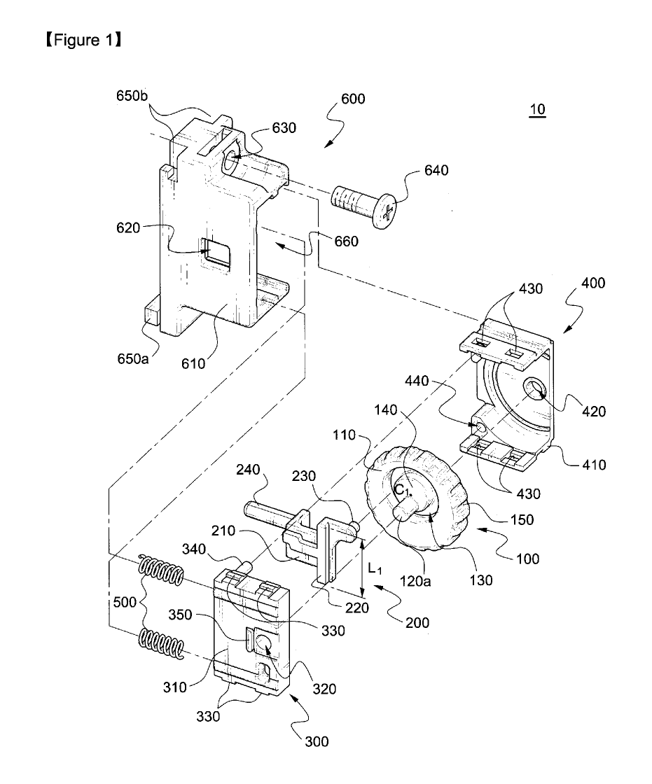

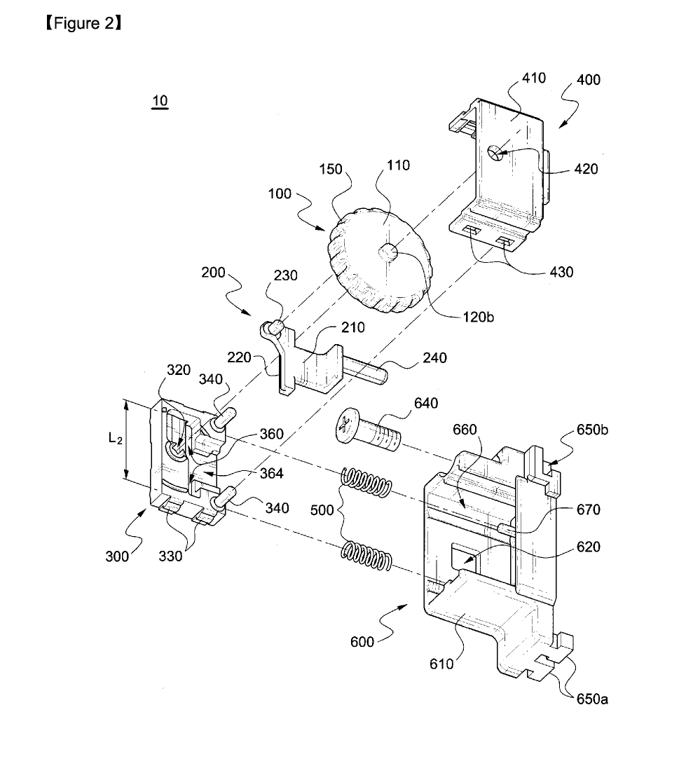

FIGS. 1 and 2 show an exploded state of a lens actuator (10) for focusing according to a preferred embodiment of the present invention, and the details of the lens actuator (10) are going to be described referring to them. The lens actuator (10) includes a dial (100) for focusing, a lens-actuating member (200) engaged with the dial (100) through a guide projection (230) inserted in an offset ring-shaped groove (130) thereof, and brackets (300, 400) supporting rotatably the dial (100).

The dial (100) has a body (110) of a shape of disc or wheel, and rotation shafts (120a, 120b) extending by a predetermined length from both of right and left surfaces thereof perpendicularly to opposite directions. On at least one side surface of the body (110) is provided the ring-shaped groove (130). The rotation shaft (120a) is enclosed in the ring-shaped groove (130). The ring-shaped groove (130) is positioned between two concentric circles with different radii. A center (C₁) of the ring-shaped groove (130) is offset from that of the rotation shaft (120a), and does not coincide with a center of the dial (100) (that is, the centers of the rotation shaft (120a, 120b)). Therefore, a portion (140) of the dial body inside the inner circle of the ring-shaped groove (130) functions as a cam in rotation of the rotation shaft (120a). The dial (100) is preferably provided with groove-protrusions (150) around its circumferential side edges. They are for preventing human fingers from being slipped over it when a user rotates the dial (100).

The lens-actuating member (200) has a structure, in which the protruding portion (220), the guide projection (230), and the lens-actuating shaft (240) are connected into one with the base portion (210) as a center. The base portion (210) is kept with a gap in parallel away from a surface where the offset ring-shaped groove (130) of the dial (100) is formed, and the overall shape is an L-shape, which in order to minimize the space to take up, for example, encloses a top surface or a bottom surface and a portion of side surface of the dial (100). The protruding portion (220) protrudes to the opposite side of the dial (100) at one side of the base portion (210), and extends long in an optical axial direction of a movable lens (722), the actuated lens. The guide projection (230) protrudes in the rotation shaft direction of the dial (100) at a top end of the base portion (210), and is inserted in the offset ring-shaped groove (130). The lens-actuating shaft (240) is extended from the bottom end of the base portion (210) so as to protrude by a predetermined length off the dial (100) in a direction perpendicular to the optical axial direction of the movable lens (722) (or the length direction of the protruding portion (220)). A part of the end of the lens-actuating shaft (240) is inserted into and engaged to a movable lens part (720), delivering the operational power.

The first bracket (300) and the second bracket (400) face each other, and an engaging protrusion (330) provided in a body (310) of the first bracket (300) engages an engaging groove (430) provided in a body (410) of the second bracket (400), providing a receiving space. And in the receiving space are received the dial (100) and the lens-actuating member (200) engaging thereto. The rotation shafts (120a, 120b) of the dial (100) are inserted into a shaft-supporting hole (320) provided in the body (310) of the first bracket (300) and a shaft-supporting hole (420) provided in the body (410) of the second bracket (400), respectively, to be supported rotatably.

In the first bracket (300) is provided a retaining groove (360). The retaining groove (360) is formed long in an optical axial direction of the movable lens (722). In the retaining groove (360) is inserted the protruding portion (220) of the lens-actuating member (200). The length (L₂) of the retaining groove (360) is made a little longer than the length (L₁) of the protruding portion (220) in the optical axial direction. The length difference of them is above the maximum movement length of the lens-actuating member (200) in the optical axial direction. Instead the width of the retaining groove (360) is made similar to the width of the protruding portion (220). The protruding portion (220) is inserted in the retaining groove (360), and restrained so as to move forward and backward by the predetermined distance in its length direction (that is, the optical axial direction) but not to move in its width direction (that is, a direction perpendicular to the optical axial direction). In the first bracket (300) is provided a redundant space (364) for allowing a movement of the base portion (210) and the lens-actuating shaft (240) of the lens-actuating member (200) in the optical axial direction. In order to guarantee the engagement of the two brackets (300, 400) kept further, an engaging shaft (340) and an engaging hole (440) that engage together by inserting each other may be further provided respectively.

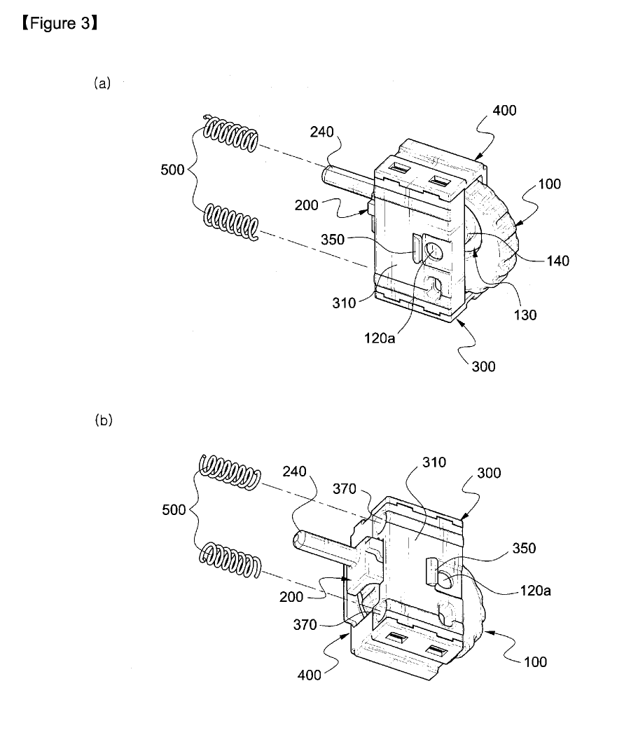

FIGS. 3(a) and 3(b) show an assembled state, viewed diagonally from the top and the bottom, in which the dial (100) and the lens-actuating member (200) are assembled by brackets (300, 400) of some components of the lens actuator (10). As illustrated, a portion of the dial (100) received in the brackets (300, 400) is exposed to outside of the top portion of the brackets (300, 400). The dial (100) can be rotated by touching a finger to the exposed portion. Also, a portion of the lens-actuating shaft (240) of the lens-actuating member (200) is exposed to outside of the bottom portion of the brackets (300, 400). The exposed portion of the lens-actuating shaft (240) is inserted and engaged to the lens assembly (700), delivering an operational power.

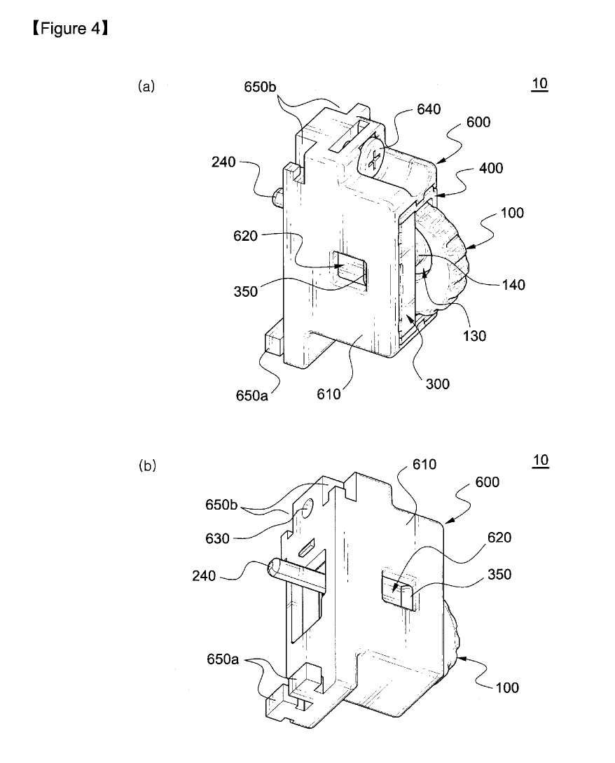

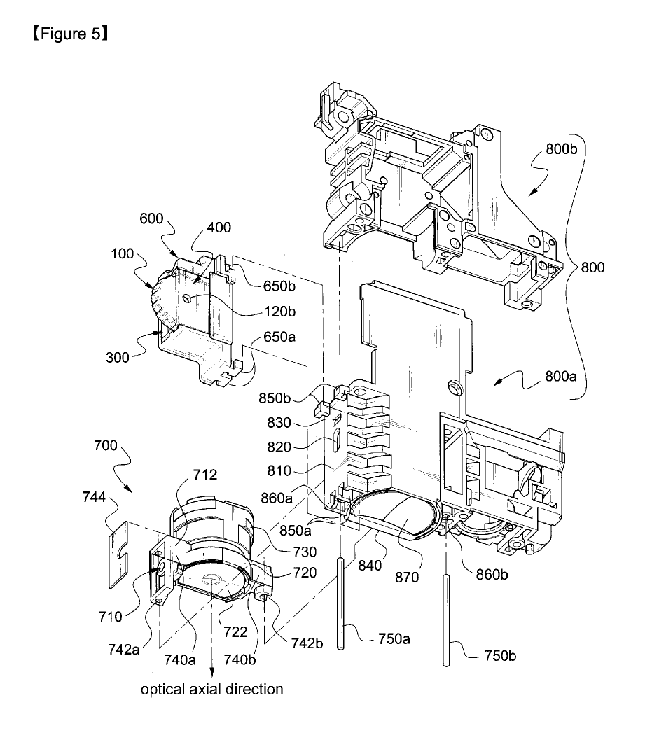

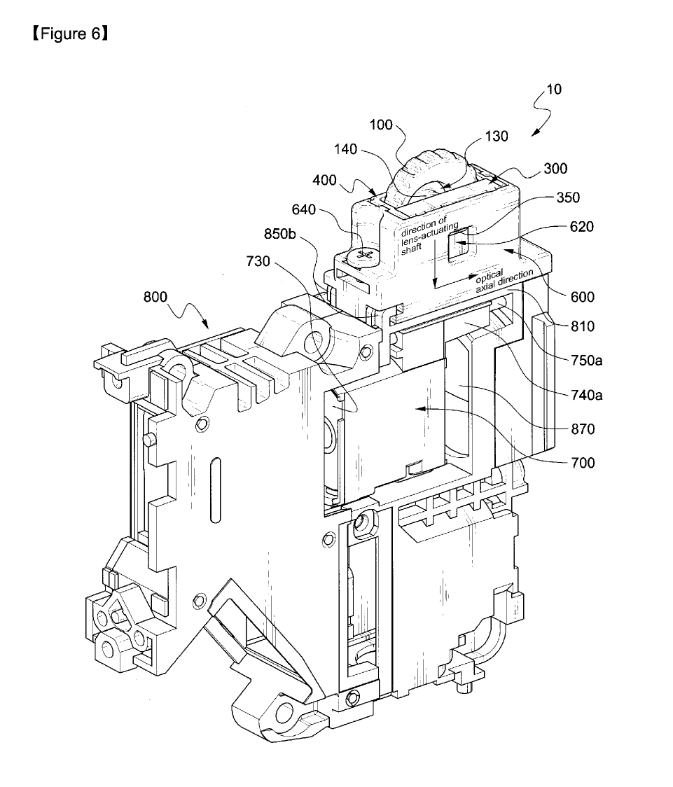

Next, referring FIGS. 4-6 further, it is explained to assemble the lens actuator (10) with a lens assembly and use the lens actuator (10) as a focusing means of lens. FIGS. 4(a) and 4(b) show an assembled state of the lens actuator (10) having a lens actuator housing (600) viewed diagonally from the top and the bottom. FIGS. 5 and 6 are an exploded perspective view and an assembled state showing how to assemble the lens actuator (10), a lens assembly (700), and a lens-assembly housing (800).

The lens actuator (10) needs to be assembled with the lens assembly (700) in order to be used as a focusing means of lens. Assembling the lens actuator (10) with the lens assembly (700) is accomplished by engaging with a lens-assembly housing (800) which receives the lens assembly (700) therein. The lens actuator (10) may engage with the lens-assembly housing (800) directly, but as shown in FIGS. 1-6, it may further comprise a lens actuator housing (600) and may be engaged therethrough.

The lens actuator housing (600) comprises a body (610) providing a receiving space (660). The brackets (300, 400) engages the lens actuator housing (600) by being inserted into the receiving space (660) from the top side of the lens actuator housing (600). In order to guarantee such engagement and keep it a stable one, in the external surface of the brackets (300, 400) and inside the lens actuator housing (600) are provided a guide groove and a guide projection in a direction of the insertion, respectively.

In the lens actuator housing (600) is further provided a fixing means for engaging with the lens-assembly housing (800). The fixing means, for example, may be an engaging protrusion (650a) and an engaging groove (650b) provided on both of right and left sides of a bottom portion of the body (610). And in proximity of the engaging groove (650b) may be further provided an engaging hole (630).

Corresponding to the engaging protrusion (650a) and the engaging groove (650b) of the lens actuator housing (600), in the first housing (800a) of the lens-assembly housing (800) is provided a platform (810) where the lens actuator housing (600) is disposed, and on the right and left sides thereof are provided an engaging groove (850a) and an engaging protrusion (850b) in pair so as to engage the engaging protrusion (650a) and the engaging groove (650b). Also, at a specific location of the platform (810) facing the engaging hole (630) is provided an engaging hole (830). The engaging protrusion (650a) and the engaging groove (650b) of the lens actuator housing (600) engage the engaging groove (850a) and the engaging protrusion (850b) of the lens-assembly housing (800) respectively, and an engaging pin (640) penetrates the engaging hole (630) and is inserted into and engaged with the engaging hole (830) of the platform (810), such that the lens actuator housing (600) is fixed to the lens-assembly housing (800). The lens-assembly housing (800) may be formed by combining a first housing (800a) and a second housing (800b).

On the bottom side of the platform (810) is provided a lens-receiving member (840), the lens assembly (700) is installed therein, and at the foremost side of the lens-receiving member (840) is provided a lens cover (870). In the middle of the platform (810) is provided a through hole (820) through which the lens-actuating shaft (240) penetrates. In order that the lens-actuating shaft (240) is guaranteed to move forward and backward in the optical axial direction, the through hole (820) needs to be made long in that direction. Also to the upper side and the lower side of the lens-receiving member (840) are provided though-holes (860a, 860b) through which guide bars (750a, 750b) are inserted.

A means for fixing the lens actuator housing (600) in the lens-assembly housing (800) might not be provided as in the above, but it may be provided in one side only. Also, even though not shown, instead of adopting the lens actuator housing (600) separately the alternative schemes may be possible as follows: a scheme in which engaging means for engaging the lens-assembly housing (800) such as the engaging protrusion (650a) and the engaging groove (650b) may be further provided in the brackets (300, 400); another scheme in which a separate engaging means allowing direct engagement with the brackets (300, 400) may be further provided on the lens-assembly housing (800); or still another scheme in which two engaging means for engaging each other are provided on both sides of the brackets (300, 400) and the lens-assembly housing (800).

Referring to FIG. 5, the lens assembly (700) comprises at least one movable lens part (720) which holds and supports the movable lens (722), an actuated lens. On the two facing side portions of the movable lens part (720) is included a first guide member (740a) and a second guide member (740b), which engage guide bars (750a, 750b) and guided thereby in moving. In the first guide member (740a) and the second guide member (740b) are provided a guide hole (742a) and a guide groove (742b) respectively, and if the lens assembly (700) is received precisely in the lens-receiving member (840) these guide hole and groove (742a, 742b) face the through holes (860a, 860b) exactly respectively. The two guide bars (750a, 750b) are inserted into the guide hole (742a) and the through hole (860a), and the guide groove (742b) and the through hole (860b), respectively. In the first guide member (740a) is provided a shaft-engaging hole (710) such that the lens-actuating shaft (240) is inserted in a direction (a direction of actuating shaft) perpendicular to the optical axial direction. The shaft-engaging hole (710) has a depth such that the lens-actuating shaft (240) can go up and down by a predetermined height (a height of a restraining groove (620) to be described below) in a direction of the actuating shaft. The top portion of the first guide member (740a) is finished with a cover (744). The lens assembly (700) may further comprise projection lens or other type of lens (730) (however, these are not an actuated lens, but a fixed lens).

By the way, the lens actuator (10) may further comprise a shock-absorbing means for absorbing shock from outside. More specifically, on a bottom surface of the first bracket (300) are provided spring-inserting holes (370) formed upward by a predetermined depth, and into the spring-inserting holes (370) are inserted the coil springs (500) respectively. Since the length of the coil spring (500) is longer than the depth of the spring-inserting hole (370), a part of the coil spring (500) is exposed to outside. Also, on one side surface of the first bracket (300) is provided a restraining protrusion (350), and on a corresponding side surface of the lens actuator housing (600) is provided a restraining groove (620) into which the restraining protrusion (350) is inserted. The restraining groove (620) is provided in a shape of rectangle having a predetermined height in the direction of the actuating shaft. The restraining protrusion (350) is restrained so as not be disengaged from the restraining groove (620), moving inside only in the direction of the actuating shaft.

If the brackets (300, 400) are received in the receiving space (660) of the lens actuator housing (600), the restraining protrusion (350) is inserted in the restraining groove (620), and at the same time the coil spring (500) is compressed between the floor of the lens actuator housing (600) and the floor of the spring-inserting hole (370). In such a state, the compressed coil spring (500) pushes the brackets (300, 400) upward of the lens actuator housing (600), and the restraining protrusion (350) is hooked on the top surface of the restraining groove (620), and the brackets (300, 400) keep engaging with the coil spring (500) in that state.

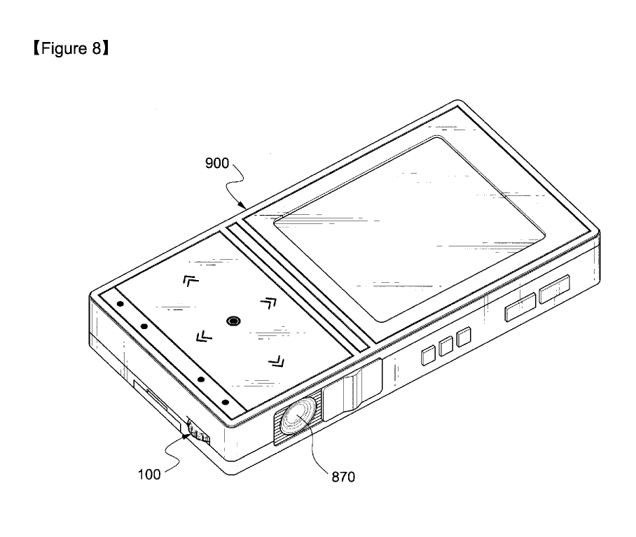

In such an engagement, the coil spring (500) only touches the floor of the lens actuator housing (600), and by the elastic force of the coil spring (500) the bottom surfaces of the brackets (300, 400) are detached from the floor of the lens actuator housing (600). This engagement can mitigate an external shock even though the external shock is applied to the dial (100). FIG. 8 shows a mobile phone (900) installed with a micro projector which is formed with the lens actuator (10) according to the invention, the lens assembly (700), and the lens-assembly housing (800). In this application, a part of the dial (100) is exposed externally. If an unintended external force or shock pressing down the dial (100) from above is applied, the shock is absorbed while the coil spring (500) is compressed first. If there is no such a shock-absorbing means, the shock applied to the dial (100) would be delivered directly to the brackets (300, 400) and the lens-actuating member (200) through the rotational shaft (120a, 120b) of the dial (100) and a wall of the offset ring-shaped groove (130) respectively. If the external shock is applied frequently, the lens-actuating member (200) may be deformed or bent, and in worst cases, the components may be damaged. However by the above shock-absorbing means, if the external shock is not large enough to overcome the restoring force of the coil spring (500), the bottom surface of the brackets (300, 400) do not touch the floor of the lens actuator housing (600), and then since the shock is absorbed by the coil spring (500) the lens-actuating member (200) would not be deformed or damaged.

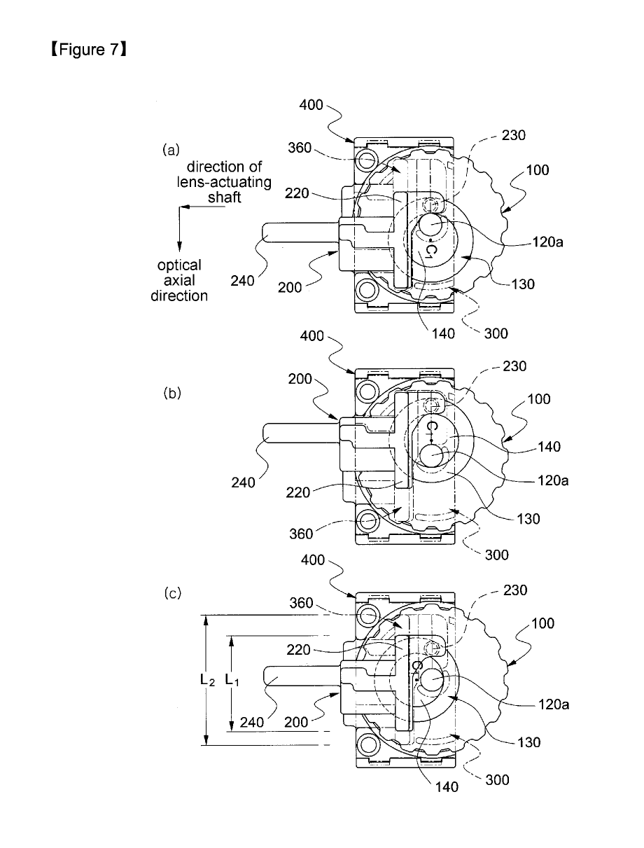

Next, FIG. 7 shows operational states of the lens actuator (10) according to the invention. Referring to it, the operation of the lens actuator (10) is explained. FIGS. 7(a) and 7(b) show a state in which the guide projection (230) of the lens-actuating member (200) is positioned closest to the rotation shaft (120a) of the dial (100) (referred as ‘closest state’ below) and a state in which it is positioned farthest (referred as ‘farthest state’), and FIG. 7(c) shows a state in which the guide projection (230) is detached from the rotation shaft (120a) by an intermediate state between the above two states (referred as ‘intermediate state’).

In the closest state of FIG. 7(a), the protruding portion (220) of the lens-actuating member (200) is leant to the foremost of the retaining groove (360) provided in the first bracket (300) when viewing in the optical axial direction. In this state, if a user rotates the dial (100) by 180 degrees clockwise or counterclockwise using a finger, the side wall of the offset ring-shaped groove (130) rotates whiling pushing the guide projection (230), reaching the farthest state of FIG. 7(b) via the intermediate state of the FIG. 7(c). More specifically, the force by which the side wall of the offset ring-shaped groove (130) pushes the guide projection (230) has a component in the optical axial direction and another component in the direction of the actuating shaft. Since the protruding portion (220) of the lens-actuating member (200) is restrained from moving in the direction of the actuating shaft by the retaining groove (360) of the first bracket (300), just the force of the component in the optical axial direction acts effectively. Thus, the protruding portion (220) moves upto the hind end of the retaining groove (360) along the negative optical axial direction of the retaining groove (360) and transits to the farthest state. Such movements may be viewed as a result that the dial body portion (140) enclosed by the ring-shaped groove (130) functions as a cam with respect to the lens-actuating member (200). And in addition to such state transition, the lens-actuating shaft (240) of the lens-actuating member (200) moves in the negative optical axial direction by (L₂-L₁), a difference between the lengths of the retaining groove (360) and the protruding portion (220).

If rotating the dial (100) in the farthest state by 180 degrees more in the same direction, the side wall of the offset ring-shaped groove (130) applies force to the guide projection (230) by the same principle, and as a result the protruding portion (220) moves in the optical axial direction along the retaining groove (360), and ten returns to the closest state of FIG. 7(a) via the intermediate state of FIG. 7(c). Concurrently, the lens-actuating shaft (240) moves by the length difference (L₂-L₁) in the optical axial direction.

As such, a 360 degree revolution of the dial (100) forces the lens-actuating shaft (240) to move forward and backward by the predetermined distance (L₂-L₁) in the optical axial direction, and as a result the movable lens part (720) attached to the lens-actuating shaft (240) is also forced to move by the same distance in the negative optical axial direction along the guide bars (750a, 750b). Since the movable lens part (720) can move by the predetermined distance (L₂-L₁) in the optical axial direction, the focus of the lens assembly can be adjusted by such movements.

And since such a lens actuating power is obtained by a relative rotation between the guide projection (230) and the ring-shaped groove (130), even though the dial (100) is rotated many times in a same direction, the lens-actuating shaft (240) repeats to move forward and backward in the predetermined distance (L₂-L₁). Also, rotating the dial (100) many times clockwise produces the same results as rotating the dial (100) many times counterclockwise in moving forward and backward of the lens-actuating shaft (240).

### INDUSTRIAL APPLICATIONS

The lens actuator for focusing according to the present invention may be applied widely as a lens-focusing means for an optical device adopting lens. Especially since it can be made a compact module, it is suitable to be applied as a lens actuator for focusing, for example, a portable micro projector.

1. A lens actuator for focusing comprising:
a bracket with a retaining groove provided elongatedly in an optical axial direction of a movable lens means;
a dial for focusing rotatably supported by the bracket, and comprising a ring-shaped groove offset from a rotation center on at least one body surface; and
a lens-actuating member comprising a guide projection inserted into the ring-shaped groove, a protruding portion inserted into the retaining groove of the bracket, and a lens-actuating shaft extending out from the bracket,
wherein when the dial is rotated clockwise or counterclockwise the lens-actuating shaft is moved forward and backward by a predetermined distance in an optical axial direction by means of the combined forces applied by the offset ring-shaped groove guiding the guide projection and the retaining groove allowing the protruding portion to move in the optical axial direction, but not in a direction of the lens-actuating shaft that is perpendicular to the optical axial direction.

2. The lens actuator for focusing of claim 1, wherein if the dial keeps rotating clockwise or counterclockwise, the lens-actuating shaft is configured to keep moving forward and backward one time by the predetermined distance along the optical axial direction for every rotation of the dial.

3. The lens actuator for focusing of claim 1, wherein the lens-actuating shaft of which end portion is inserted into and engaged with the movable lens means delivers a force to the movable lens means so as to move forward and backward by the predetermined distance along the optical axial direction when the lens-actuating shaft moves forward and backward in the optical axial direction.

4. The lens actuator for focusing of claim 3, further comprising a lens-assembly housing for receiving the movable lens means slidably along a guide member provided in the optical axial direction.

5. The lens actuator for focusing of claim 1, further comprising a lens actuator housing which receives an assembly of the dial, the lens-actuating member, and the bracket therein and is fixed to a lens-assembly housing in which the movable lens means is installed while exposing a portion of the dial and a portion of the lens-actuating shaft to outside of top and bottom thereof.

6. The lens actuator for focusing of claim 5, wherein an engaging means for fixing the lens actuator housing to the lens-assembly housing is provided in at least one of the lens actuator housing and the lens-assembly housing.

7. The lens actuator for focusing of claim 5, further comprising a shock-buffering means, which is disposed between the bracket and the lens actuator housing, makes the bottom of the bracket detached from the floor of the lens actuator housing, and buffers shock against an external force when the external force is applied and presses down on the dial.

8. The lens actuator for focusing of claim 7, wherein a retaining protrusion is further provided in one side of the bracket, and a retaining groove for restraining the retaining protrusion inserted therein so as not to disengage and allowing movement within a predetermined distance in the direction of the lens-actuating shaft is further provided in a corresponding side of the lens actuator housing.

9. The lens actuator for focusing of claim 1, further comprising an engaging means for fixing the bracket to a lens-assembly housing in at least one of the lens-assembly housing in which the movable lens means is installed and the bracket.

10. The lens actuator for focusing of claim 9, further comprising a shock-buffering means, which is disposed between the bracket and the lens-assembly housing, makes the bottom of the bracket detached from the floor of the lens-assembly housing, and buffers shock against an external force before the bottom of the bracket touches the surface of the lens-assembly housing when the external force pressing down on the dial is applied.

11. The lens actuator for focusing of claim 1, wherein the dial is provided with a rotational axis at the center of rotation of a body having a shape of disc or wheel, and the portion of the body enclosing the rotational axis and enclosed by the offset ring-shaped groove functions as a cam with respect to the lens-actuating member.
